(19) United States
(12) Patent Application Publication
(10) Pub. No.: US 2015/0215535 A1
(43) Pub. Date: Jul. 30, 2015

(54) Restriction System

(71) Applicant: Kazuki Takahashi, Toronto (CA)

(72) Inventor: Kazuki Takahashi, Toronto (CA)

(21) Appl. No.: 14/164,084

(22) Filed: Jan. 24, 2014

(51) Int. Cl. H04N 5/232; H04N 5/225

(52) U.S. Cl. CPC H04N 5/23245; H04N 5/2254; H04N 5/2257

(57) ABSTRACT

A restriction system selectively restricts a camera on a communication device from recording an image. The system includes a barrier portion that engages the camera. The barrier portion moves along a camera proximal area to better engage the camera. The barrier portion moves in front of the camera to at least partially restrict the camera view and create a blocked position. The barrier portion also moves away from the camera view to enable the camera to record an image, in an open position. At least one barrier fastener helps secure a mounting surface on the barrier to the camera proximal area. A front surface of the barrier displays a decorative indicia. While in the open position an alert portion, such as colored stones, displays to signal that the camera is operable to capture images. This serves as a visual reminder. The alert portion is covered in the blocked position.

### CROSS-REFERENCE TO RELATED APPLICATIONS

Not applicable.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to camera view barriers. More particularly, the invention relates to a barrier that moves for restricting and enabling viewing from a camera and alerting of the position.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a webcam is a video camera that feeds its image in real time to a computer or computer network.

Typically, a webcam aligns at a sight advantageous for viewing a user operating a computer. In this manner, the viewer may visually communicate with others directly from the computer. The webcam view may be operable, even when the computer is not operating. A user may often forget that the camera is potentially operable.

In many instances, barrier or barricade is a physical structure which blocks or impedes something. The barrier can be moved between a blocking position and an open position that does not impede. Barriers come in many sizes and operate differently, depending on the thing requiring blockage.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A and 1B illustrate detailed perspective views of an exemplary restriction system, with FIG. 1A illustrating an exemplary barrier portion in a restrict position, and FIG. 1B illustrating an exemplary barrier portion in an open position, in accordance with an embodiment of the present invention;

FIGS. 2A, 2B, and 2C illustrate various views of an exemplary barrier portion, where FIG. 2A illustrates a frontal view of an exemplary barrier front surface, FIG. 2B illustrates a rear view of an exemplary barrier mounting surface having at least one barrier fastener, and FIG. 2C illustrates a top side view of an exemplary barrier portion, in accordance with an embodiment of the present invention;

FIGS. 3A and 3B illustrate detailed perspective views of exemplary fasteners, with FIG. 3A illustrating an exemplary at least one camera fastener having a female configuration, and FIG. 3B illustrating an exemplary at least one barrier fastener having a male configuration, in accordance with an embodiment of the present invention;

FIGS. 4A and 4B illustrate detailed perspective views of an exemplary alert portion, with FIG. 4A illustrating an exemplary alert mounting surface, and FIG. 4B illustrating an exemplary alert display surface, in accordance with an embodiment of the present invention; and

FIG. 5 illustrates a block diagram depicting an exemplary client/server system which may be used by an exemplary web-enabled/networked embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

The present invention will now be described in detail with reference to embodiments thereof as illustrated in the accompanying drawings.

There are various types of camera viewing restriction systems that may be provided by preferred embodiments of the present invention. In one embodiment of the present invention, the restriction system may selectively restrict a camera on a communication device from recording an image. The system may include a barrier portion that restricts a camera view through a camera. The camera may be positioned on a communication device, as a separate component thereof. The barrier portion may be sufficiently interchangeable to operate on a plurality of communication devices. The barrier portion may move along a camera proximal area to better engage the camera. The barrier portion may move in front of the camera to at least partially restrict the camera view, and thereby inhibiting the camera from recording an image by blocking the camera view. The barrier portion may also move away from the camera view to enable the camera to record an image.

In some embodiments, the restriction system may include an alert portion, such as a glitter stone. The alert portion may be configured to provide an alert, or catch the attention of a user when the camera view is unrestricted by the barrier portion, and thereby operable to view through. The alert portion, in essence, serves as a visual reminder. The alert portion may include a highly visible decorative signal that fastens in the camera proximal area, such that a user may be reminded that the camera is unrestricted. An alert portion displays on the camera proximal area to alert that the barrier is in an open position, and thereby, the camera is enabled to view through or capture an image. In essence, the alert portion may serve to alert when the camera is unrestricted, and thereby potentially recording an image. Those skilled in the art will recognize that it may be undesirable to allow an unrestricted camera view for an unattended camera. A user may forget to restrict the camera view, and the camera may record without the user's permission if the view is unrestricted. The barrier portion restricts the capacity of the camera to record in this unauthorized manner.

The barrier portion may position on a camera proximal area for at least partially restricting and enabling the camera view. The barrier portion may include a mounting surface for mounting to the camera proximal area, and a front surface that faces the user and may include decorative indicia. The barrier portion may move into a restrict position, in front of the camera view for restricting the view through the camera. The barrier portion may also move away from the camera view to an open position, which allows the camera view a clear path to record the image. In some embodiments, the barrier portion may removably join with the camera proximal area through at least one barrier fastener and at least one camera fastener. In one embodiment, the fasteners may include two sets of magnetic buttons that attract each other magnetically and through frictional engagement.

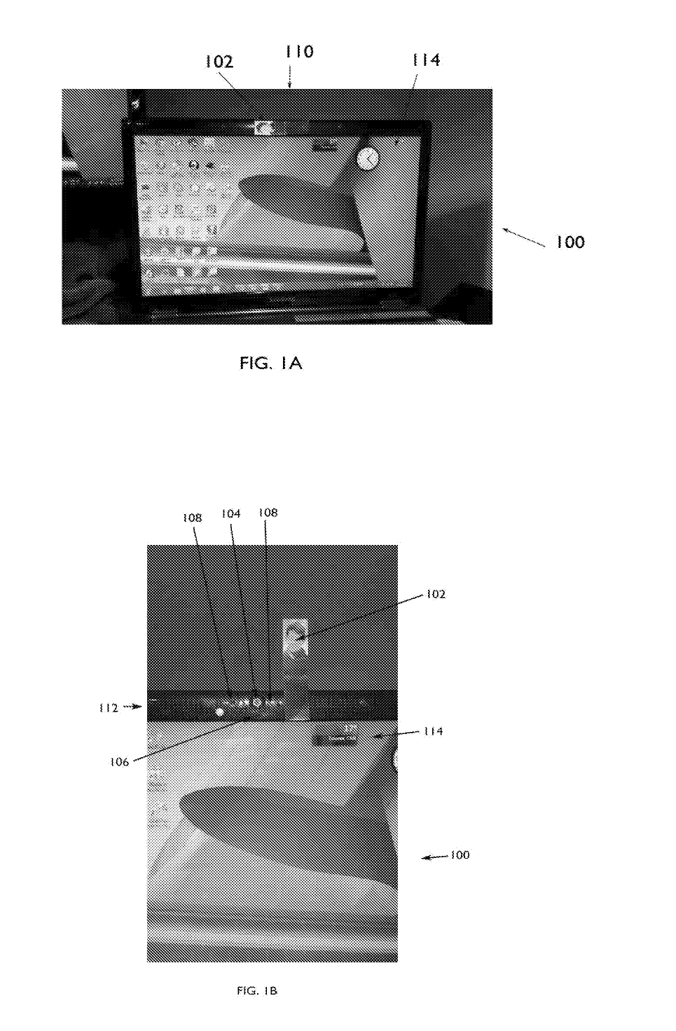

FIGS. 1A and 1B illustrate detailed perspective views of an exemplary restriction system, with FIG. 1A illustrating an exemplary barrier portion in a restrict position, and FIG. 1B illustrating an exemplary barrier portion in an open position, in accordance with an embodiment of the present invention. In the present invention, a restriction system 100 may selectively restrict a camera on a communication device. The system may include a barrier portion 102 that engages a camera 104 for at least partially restricting the camera from capturing an image. The camera may be positioned on a communication device 114, as a separate component thereof. The communication may include, without limitation, a laptop, a computer, a smart television, a smart phone, a tablet, and a security camera in a bedroom or office. The camera may integrate into the communication device and include, without limitation, a webcam, a phone camera, and a digital camera. In this manner, the barrier portion joins with a camera proximal area 106 on the communication device to engage the camera. In some embodiments, the barrier portion may be sufficiently interchangeable to operate on a plurality of communication devices. In one embodiment, the barrier portion can completely detach from the communication device.

The barrier portion may move along the camera proximal area to better engage the camera. The barrier portion may move in front of the camera to a block position 110 for at least partially restrict the camera from recording an image, and thereby blocking the camera view. The barrier portion may also move away from the camera view to an open position 112 for enabling the camera to record an image. The barrier portion may be sized and dimensioned to form a physical barrier over the camera. In some embodiments, the barrier portion may include, without limitation, a rectangular shape, a square shape, a triangular shape, and a circular shape.

While in the open position, the barrier portion may expose an alert portion 108 on the camera proximal area. The alert portion may serve to visibly alert, or catch the attention of a user for indicating that the camera is in an open position, and thereby operable. The alert portion, in essence, serves as a visual reminder. In some embodiments, the barrier portion may orient horizontally across the camera proximal area to restrict the camera view in the block position. The barrier portion may then hinge on one end to form the open position that enables the camera a free view in front of the communication device. However in other embodiments, the barrier portion may also orient vertically in the block position, horizontally in the open position, at an angle, and completely detach from the communication device in the open position. For example, without limitation, the restriction system may provide a solution to block a webcam to protect the privacy of a user from webcam spying. The restriction system may utilize an alert portion, such as glistening stones or any glistening object that is easily spotted. In one embodiment, the alert portion comprises four glitter stones that adhesively stick adjacent to a webcam lens. The highly reflective and colorful properties of the glitter stones may be spotted easily due to their color and glittering effect when the webcam is not blocked by the barrier portion.

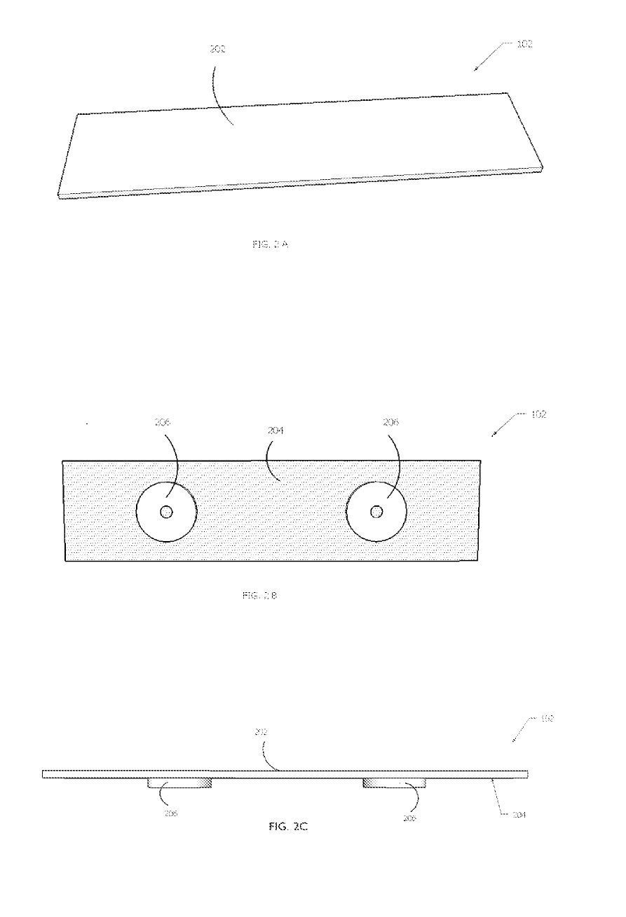

FIGS. 2A, 2B, and 2C illustrate various views of an exemplary barrier portion, where FIG. 2A illustrates a frontal view of an exemplary barrier front surface, FIG. 2B illustrates a rear view of an exemplary barrier mounting surface having at least one barrier fastener, and FIG. 2C illustrates a top side view of an exemplary barrier portion, in accordance with an embodiment of the present invention. In the present invention, the barrier portion may position on a camera proximal area for at least partially restricting and enabling the camera view. The barrier portion may include a mounting surface 204 for mounting to the camera proximal area, and a front surface 202 that faces the user and may include decorative indicia. The barrier portion may move into a restrict position, in front of the camera view for restricting the view through the camera. The barrier portion may also move away from the camera view to an open position, which allows the camera view a clear path to record the image. At least one barrier fastener 206 may fasten the mounting surface to the camera proximal area. The at least one barrier fastener may join with at least one camera fastener that positions in alignment on the camera proximal area.

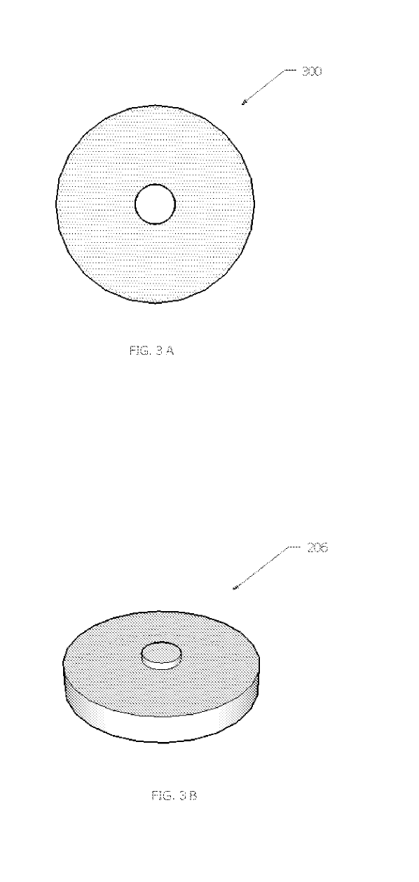

FIGS. 3A and 3B illustrate detailed perspective views of exemplary fasteners, with FIG. 3A illustrating an exemplary at least one camera fastener having a female configuration, and FIG. 3B illustrating an exemplary at least one barrier fastener having a male configuration, in accordance with an embodiment of the present invention. In the present invention, the barrier portion may removably join with the camera proximal area through at least one barrier fastener and at least one camera fastener 300. Each fastener is configured to restrict movement of the barrier portion, whether in the block position or the open position. A force may be sufficient to detach the fasteners from each other for moving the barrier portion. In one embodiment, the fasteners may include two sets of magnetic buttons that attract each other magnetically and through frictional engagement. The at least one barrier fastener may include a male configuration configured to frictionally snap and attach with a female configuration of the corresponding at least one camera fastener. Additional barrier fasteners may include, without limitation, hook and loop fasteners, removable stickers, tape, and mechanical fasteners.

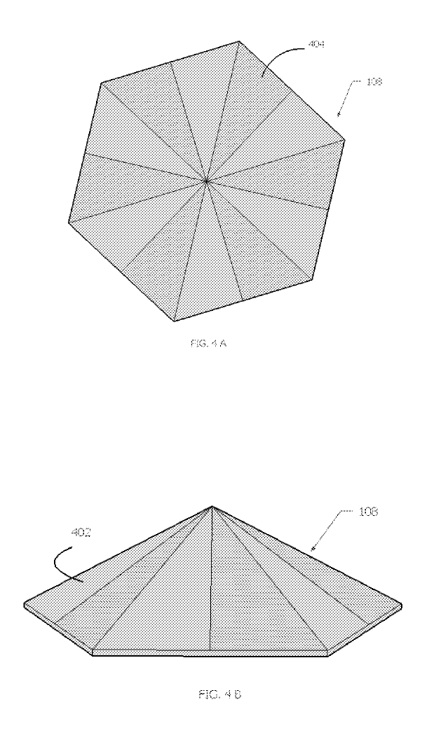

FIGS. 4A and 4B illustrate detailed perspective views of an exemplary alert portion, with FIG. 4A illustrating an exemplary alert mounting surface, and FIG. 4B illustrating an exemplary alert display surface, in accordance with an embodiment of the present invention. In the present invention, the restriction system may include an alert portion that provides an alert, or catches the attention of a user when the camera view is unrestricted by the barrier portion, and thereby operable to view through. The alert portion may include a highly visible member that fastens in the camera proximal area, such that a user may be reminded that the camera is unrestricted. The alert portion may include an alert display surface 402 visible when the barrier portion is in the open position. The alert portion may be configured to attract attention of the user towards the camera proximal area. In this manner, the alert portion indicates that the camera view is unrestricted and thereby operable. The user may then move the barrier portion to the block position if desired.

The alert portion may include, without limitation, a series of red glitter stones that align in the camera proximal area, a glitter, illumination devices, light bulbs, sparklers, refracting lenses, and semi-precious gems, both real and artificial. In any case, the alert portion is configured and positioned to attract the attention of the user when the barrier is in the open position, away from the camera view. The alert portion may include an alert mounting surface 404 that joins with the camera proximal area. A fastener, such as an adhesive a magnet, and a hook and loop fastener may adhere the alert mounting surface with the camera proximal area.

In some embodiments, the alert portion displays on the camera proximal area to alert that the barrier is in an open position, and thereby, the camera is enabled to view through or capture an image. In essence, the alert portion may serve to alert when the camera is unrestricted, and thereby potentially recording an image. Those skilled in the art will recognize that it may be undesirable to allow an unrestricted camera view for an unattended camera. A user may forget to restrict the camera view, and the camera may record without the user's permission if the view is unrestricted. The barrier portion restricts the capacity of the camera to record in this unauthorized manner. In some embodiments, the alert portion may include motion detector software while in the open position, and thus the alert portion may provide an audible signal. The alert portion may also include a video display.

In one alternative embodiment, the barrier portion integrates into the top edge of the laptop, sliding across the camera for the block position, and sliding into a slot in the communication device when in the open position. In one alternative embodiment, the alert portion comprises a flashing illumination, or an audio recording, or a video display. Each of these alert portions is designed to indicate that the barrier portion is in the open position, and that the camera is unrestricted and possibly recording. In yet another alternative embodiment, the camera may be positioned in a building and be part of a security system. In yet another alternative embodiment, the barrier portion moves automatically on voice command, whereby a motor slides or hinges the barrier portion to and from the camera view.

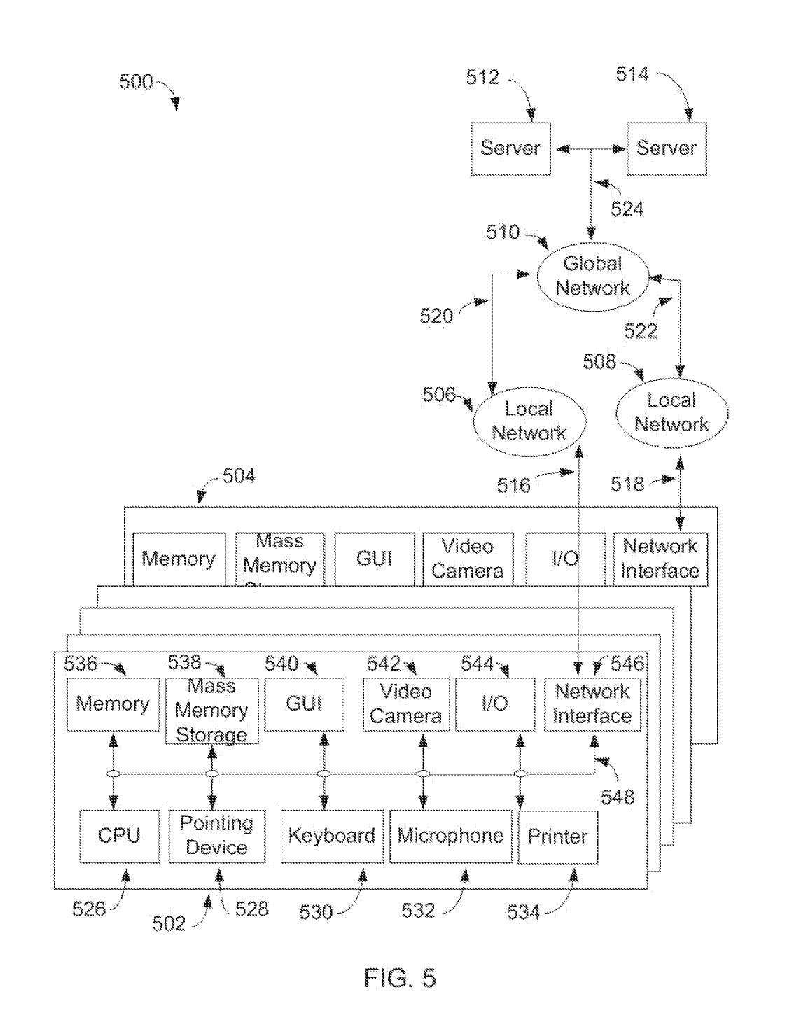

FIG. 5 illustrates a block diagram depicting an exemplary client/server system which may be used by an exemplary web-enabled/networked embodiment of the present invention. In the present invention, a communication system 500 includes a multiplicity of clients with a sampling of clients denoted as a client 502 and a client 504, a multiplicity of local networks with a sampling of networks denoted as a local network 506 and a local network 508, a global network 510 and a multiplicity of servers with a sampling of servers denoted as a server 512 and a server 514.

Client 502 may communicate bi-directionally with local network 506 via a communication channel 516. Client 504 may communicate bi-directionally with local network 508 via a communication channel 518. Local network 506 may communicate bi-directionally with global network 510 via a communication channel 520. Local network 508 may communicate bi-directionally with global network 510 via a communication channel 522. Global network 510 may communicate bi-directionally with server 512 and server 514 via a communication channel 524. Server 512 and server 514 may communicate bi-directionally with each other via communication channel 524. Furthermore, clients 502, 504, local networks 506, 508, global network 510 and servers 512, 514 may each communicate bi-directionally with each other.

In one embodiment, global network 510 may operate as the Internet. It will be understood by those skilled in the art that communication system 500 may take many different forms. Non-limiting examples of forms for communication system 500 include local area networks (LANs), wide area networks (WANs), wired telephone networks, wireless networks, or any other network supporting data communication between respective entities.

Clients 502 and 504 may take many different forms. Non-limiting examples of clients 502 and 504 include personal computers, personal digital assistants (PDAs), cellular phones and smartphones.

Client 502 includes a CPU 526, a pointing device 528, a keyboard 530, a microphone 532, a printer 534, a memory 536, a mass memory storage 538, a GUI 540, a video camera 542, an input/output interface 544 and a network interface 546.

CPU 526, pointing device 528, keyboard 530, microphone 532, printer 534, memory 536, mass memory storage 538, GUI 540, video camera 542, input/output interface 544 and network interface 546 may communicate in a unidirectional manner or a bi-directional manner with each other via a communication channel 548. Communication channel 548 may be configured as a single communication channel or a multiplicity of communication channels.

CPU 526 may be comprised of a single processor or multiple processors. CPU 526 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 536 is used typically to transfer data and instructions to CPU 526 in a bi-directional manner. Memory 536, as discussed previously, may include any suitable computer-readable media, intended for data storage, such as those described above excluding any wired or wireless transmissions unless specifically noted. Mass memory storage 538 may also be coupled bi-directionally to CPU 526 and provides additional data storage capacity and may include any of the computer-readable media described above. Mass memory storage 538 may be used to store programs, data and the like and is typically a secondary storage medium such as a hard disk. It will be appreciated that the information retained within mass memory storage 538, may, in appropriate cases, be incorporated in standard fashion as part of memory 536 as virtual memory.

CPU 526 may be coupled to GUI 540. GUI 540 enables a user to view the operation of computer operating system and software. CPU 526 may be coupled to pointing device 528. Non-limiting examples of pointing device 528 include computer mouse, trackball and touchpad. Pointing device 528 enables a user with the capability to maneuver a computer cursor about the viewing area of GUI 540 and select areas or features in the viewing area of GUI 540. CPU 526 may be coupled to keyboard 530. Keyboard 530 enables a user with the capability to input alphanumeric textual information to CPU 526. CPU 526 may be coupled to microphone 532. Microphone 532 enables audio produced by a user to be recorded, processed and communicated by CPU 526. CPU 526 may be connected to printer 534. Printer 534 enables a user with the capability to print information to a sheet of paper. CPU 526 may be connected to video camera 542. Video camera 542 enables video produced or captured by user to be recorded, processed and communicated by CPU 526.

CPU 526 may also be coupled to input/output interface 544 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 526 optionally may be coupled to network interface 546 which enables communication with an external device such as a database or a computer or telecommunications or internet network using an external connection shown generally as communication channel 516, which may be implemented as a hardwired or wireless communications link using suitable conventional technologies. With such a connection, CPU 526 might receive information from the network, or might output information to a network in the course of performing the method steps described in the teachings of the present invention.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a system that blocks a camera view and alerts when the camera view is unrestricted according to the present invention will be apparent to those skilled in the art. Various aspects of the invention have been described above by way of illustration, and the specific embodiments disclosed are not intended to limit the invention to the particular forms disclosed. The particular implementation of the system that blocks a camera view and alerts when the camera view is unrestricted may vary depending upon the particular context or application. By way of example, and not limitation, the system that blocks a camera view and alerts when the camera view is unrestricted described in the foregoing were principally directed to a barrier that moves in front of and out of the way of a webcam, and in the open position displays glitter stones to indicate the webcam is operable implementations; however, similar techniques may instead be applied to security cameras in a building that can be restricted for various reasons, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A system comprising:
a barrier portion configured to selectively restrict a camera, said barrier portion disposed to position on a camera proximal area, said barrier portion configured to move between an open position and a blocked position in relation to said camera, said open position configured to at least partially enable said camera to record an image, said blocked position configured to at least partially restrict said camera from recording said image; and
an alert portion configured to display a decorative signal when said barrier portion is in said open position.

2. The system of claim 1, in which said camera comprises a webcam.

3. The system of claim 2, in which said camera is disposed to position on a communication device.

4. The system of claim 3, in which said communication device comprises a computer.

5. The system of claim 4, in which said barrier portion comprises a rectangular shape.

6. The system of claim 5, in which said barrier portion is disposed to position horizontally in said blocked position, said barrier portion further disposed to position vertically in said open position.

7. The system of claim 6, in which said barrier portion comprises a mounting surface, said mounting surface configured to join with said camera proximal area.

8. The system of claim 7, in which said mounting surface comprises at least one barrier fastener.

9. The system of claim 8, in which said at least one barrier fastener comprises two male magnets.

10. The system of claim 9, in which said camera proximal area comprises two female magnets disposed to align with said two male magnets.

11. The system of claim 10, in which said two male magnets and said two female magnets at least partially detach to enable said barrier to pivot between said open position and said blocked position.

12. The system of claim 11, in which said barrier portion comprises a front surface.

13. The system of claim 12, in which said front surface comprises a decorative indicia.

14. The system of claim 13, in which said alert portion comprises a plurality of colored stones.

15. The system of claim 14, in which said alert portion comprises an alert mounting surface.

16. The system of claim 15, in which said alert mounting surface is configured to join with said camera proximal area.

17. The system of claim 16, in which said alert portion comprises an alert display surface.

18. The system of claim 17, in which said alert display surface is configured to display a signal when said barrier is in said open position.

19. A system comprising:
means for selectively restricting a camera with a barrier portion;
means for joining a mounting surface with a camera proximal area through at least one barrier fastener;
means for recording an image with said camera from an open position;
means for at least partially displaying an alert portion;
means for moving said barrier portion to a blocked position;
means for at least partially restricting a view of said alert portion from said blocked position; and
means for at least partially restricting said camera from recording said image.

20. A system consisting of:
a barrier portion configured to selectively restrict a camera, said camera comprising a webcam, said camera disposed to position on a communication device, said communication device comprising a computer, said barrier portion disposed to position on a camera proximal area, said barrier portion comprising a mounting surface, said mounting surface configured to at least partially mount said camera proximal area, said mounting surface comprising at least one barrier fastener, said at least one barrier fastener comprising two male magnets, barrier portion further comprising a front surface, said front surface comprising a decorative indicia, said barrier portion configured to move between an open position and a blocked position in relation to said camera, said open position configured to at least partially enable said camera to record an image, said open position comprising a vertical orientation, said blocked position configured to at least partially restrict said camera from recording said image, said blocked position comprising a horizontal orientation; and
an alert portion configured to display a decorative signal when said barrier portion is in said open position, said alert portion comprising a plurality of colored stones, said alert portion comprising an alert mounting surface, said alert mounting surface configured to join with said camera proximal area, said alert portion further comprising an alert display surface, said alert display surface configured to display a signal when said barrier is in said open position.
